(19) United States
(12) Patent Application Publication
(10) Pub. No.: US 2019/0245332 A1
(43) Pub. Date: Aug. 8, 2019

(54) ARMORED CABLE STRIPPING TOOL

(71) Applicant: Southwire Company, LLC, Carrollton, GA (US)

(72) Inventors: Roy Jackson, Carrollton, GA (US); Tayler Brinson, Mableton, GA (US)

(21) Appl. No.: 16/269,123

(22) Filed: Feb. 6, 2019

Related U.S. Application Data
(60) Provisional application No. 62/627,459, filed on Feb. 7, 2018.

(51) Int. Cl. H02G 1/16; B23D 45/16; B23D 45/00; B26B 11/00; H02G 1/12

(52) U.S. Cl. CPC H02G 1/16; B23D 45/16; B23D 45/165; B26B 11/00; H02G 1/1265; B23D 45/003

(57) ABSTRACT

A stripping tool for cutting the armor sheathing of a cable. The stripping tool includes a cable receiving handle defining a cable receiving channel and a saw handle movably mounted to the cable receiving handle. A saw assembly, including at least one saw blade, is supported by the saw handle and moveable relative to the cable receiving handle. The saw assembly configured to cut two successive wraps of the armor sheathing of the cable.

### CROSS REFERENCE TO RELATED APPLICATION

This application is a non-provisional patent application of U.S. Application No. 62/627,459, filed Feb. 7, 2018, the entire contents of which are herein incorporated by reference.

### BACKGROUND

### 1. Field of the Invention

The present invention generally relates to hand tools for stripping armored cables, metal-clad cables, and flexible metal conduits, including such cables and conduits known as AC, BX, MC cable, RWA, RWS, and SWA. More specifically, the invention relates to a hand tool for temporarily clamping a metallic sheathed cable and cutting the metal sheathing without damage to the conductors therein and allowing the metal sheathing to be stripped away from the conductors. For convenience, such cables and conduits are herein collectively referred to as just armored cable.

### 2. Description of the Related Technology

Tools of the general variety for stripping armored cable to which the present disclosure relates are disclosed in U.S. Pat. Nos. 4,769,909; 8,191,266; and 9,088,144, the disclosures of which are herein incorporated by reference. These tools have been successful in replacing the use of hacksaws for cutting armored conduits, which is difficult since, not only is the sheathing made of a metallic or other tough material, but that the armored cable tends to want to slip relative to the cutting tool, resulting in the possibility of injury to an operator or damaging of the cable materials within the sheathing. Such tools generally hold the sheathing, preventing it from slipping relative to a cutting element, and limit the depth to which the cutting element penetrates, preventing the cutting element from contacting and damaging the cable materials within the sheathing.

### SUMMARY

In overcoming the enumerated drawbacks and other limitations of the related art, the present invention provides a stripping tool is provided for cutting the armor sheathing of a cable.

In one aspect of the invention, the stripping the tool includes a cable receiving handle defining a cable receiving channel and a saw handle movably mounted to the cable receiving handle. A saw assembly, including at least one saw blade, is supported by the saw handle and moveable relative to the cable receiving handle. The saw assembly configured to cut two successive wraps of the armor sheathing of the cable.

In another aspect, the saw assembly includes two rotatable saw blades.

In a further aspect, the saw blades are axially spaced from one another.

In an additional aspect, the saw blades are rotationally coupled to one another.

In still another aspect, the saw blades are rotationally coupled to one another by a series of gears.

In yet a further aspect, the saw assembly includes two saw blades laterally spaced from one another.

In an additional aspect, the saw assembly includes two saw blades that are laterally and axially spaced from one another.

In another aspect, the saw assembly includes a saw blade axially moveable relative to the cable receiving handle between forward and rearward positions.

In still a further aspect, the saw assembly is axially moveable relative to the cable receiving handle between forward and rearward positions.

In yet an additional aspect, the saw handle is mounted to the cable receiving handle at one end of the saw handle and the saw assembly is mounted at an opposing end of the saw handle.

In another aspect, a cable engaging member is pivotally mounted relative to the cable receiving handle and pivotable between a rearward position and a forward position. In the rearward position, the cable engaging member positions the cable for cutting of one wrap of the armor sheathing. In the forward position, the cable engaging member positions the cable for cutting of a successive wrap of the armor sheathing.

In a further aspect, an integrated tape cutter formed on one of the saw handle and cable receiving handle, the tape cutter including a fixed blade.

In an additional aspect, an integrated wire stripping plies formed at least in part on the cable receiving handle, the wire stripping pliers including opposing jaws moveable relative to one another and a cutting edge defined on one of the opposing jaws.

In still another aspect, a clamping lever is pivotably mounted to the cable receiving handle. The clamping lever is coupled to a clamping stud that extends toward the saw assembly and into the channel defined in the cable receiving handle for engagement with a cable located therein.

In yet a further aspect, the clamping stud is pivotally mounted relative to the clamping lever and pivotable between a rearward position and a forward position. In the rearward position, the clamping stud positions the cable for cutting of one wrap of the armor sheathing and in the forward position the clamping stud positions the cable for cutting of a successive wrap of the armor sheathing.

In an additional aspect, the clamping lever is moveable between a locked clamped position and an unclamped position.

In another aspect, a connecting rod extends between the cable receiving handle and the clamping lever. The connecting rod is respectively pivotally connected to each of the cable receiving handle and the clamping lever at first and second pivots. A moveable linkage also extends between the clamping lever and the cable receiving handle. The moveable linkage is respectively pivotally connected to each of the clamping lever and the cable receiving handle at third and fourth pivots.

In a further aspect, the first and third pivots define a centerline extending therebetween and the second pivot is moveable between the locked clamped position on one side of the centerline and the unclamped position on the opposing side of the centerline.

In yet an additional aspect, the clamping stud is supported by the moveable linkage.

In still another aspect, the clamping stud threadably engaged with the moveable linkage and adjustable in position relative thereto.

In a further aspect, the clamping stud is received in a bore of the moveable linkage and biased with respect thereto by a spring.

### BRIEF DESCRIPTION OF THE FIGURES

FIG. 1 is a side view, with portion broken away, of a first variation of a hand tool embodying the principles of the present invention and shown with a length of armored cable extended through the cutting zone of the hand tool.

FIG. 2 is a cross-sectional view of the hand tool generally taken along line 2-2 in FIG. 1.

FIG. 3 is a side view, with portion broken away, of a second variation of a hand tool embodying the principles of the present invention and shown with a length of armored cable extended through the cutting zone of the hand tool.

FIG. 4 is an end view, with portion broken away, of a third variation of a hand tool embodying the principles of the present invention and shown with a length of armored cable extended through the cutting zone of the hand tool.

FIG. 5 is a side view, with portion broken away, of a fourth variation of a hand tool embodying the principles of the present invention and shown with a length of armored cable extended through the cutting zone of the hand tool in a first cutting position.

FIG. 6 is a side view similar to FIG. 5, but showing the length of armored cable in a second cutting position.

FIG. 7 is a side view of a fifth variation of a hand tool embodying the principles of the present invention and shown with a length of armored cable extended through the cutting zone of the hand tool.

FIG. 8 is a side view of a fifth variation of a hand tool embodying the principles of the present invention and shown with a length of armored cable extended through the cutting zone of the hand tool.

FIG. 9 is a partial view of a hand tool incorporating a tape cutting feature.

FIG. 10 is a partial view of a hand tool incorporating a wire stripping pliers feature.

Further objects, features and advantages of this invention will become readily apparent to persons skilled in the art after review of the following description, including the claim, with reference to the drawings that are appended to and form a part of this specification.

### DETAILED DESCRIPTION OF THE PREFERRED EMBODIMENTS

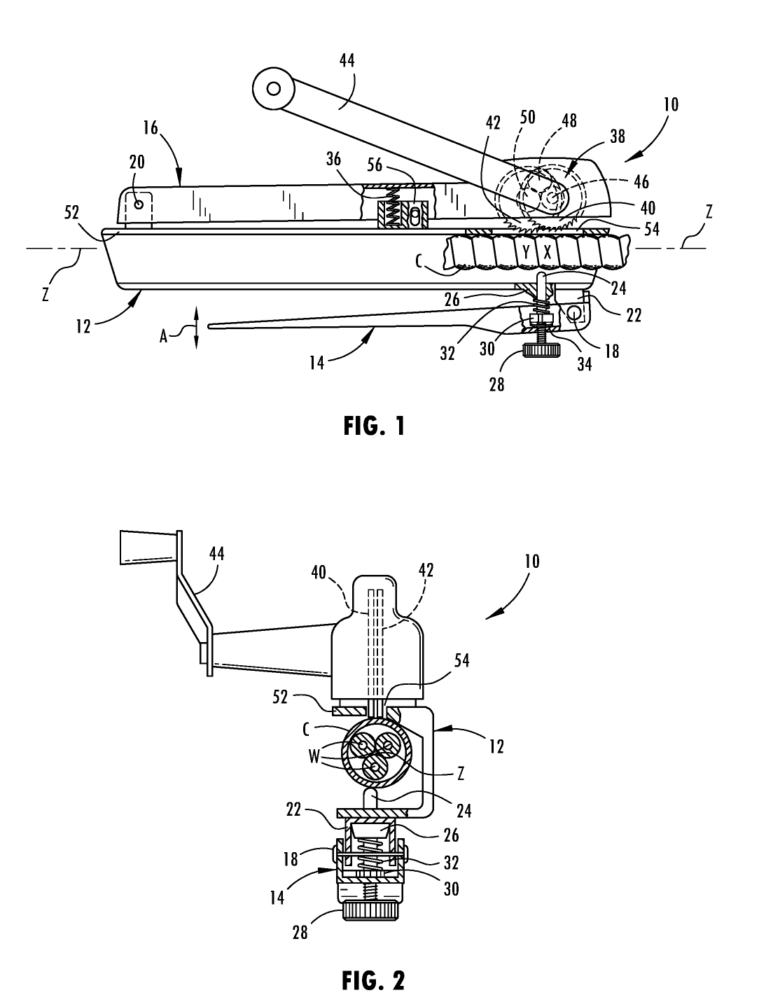

Referring now to FIG. 1, indicated generally at 10 is a hand tool embodying the principles of the present invention. The hand tool 10 includes as its principle components a cable receiving handle 12, a cable clamping lever 14 and a saw handle 16.

The cable clamping lever 14 is hingedly connected to one end of the cable receiving handle 12 by means of a front pivot 18, while the saw handle 16 is hingedly connected to the other end of the cable receiving handle 12 by means of a rear pivot 20. As is seen in FIGS. 1 and 2, the cable receiving handle 12 is C-shaped, preferably, in cross-section with the C-shape opening to a lateral side of the hand tool 10. With this shape, the cable receiving handle 12 defines a channel 21 for receiving a cable “C.”

The cable clamping lever 14 is preferably U-shaped, at least at the end containing the front pivot 18, and has an internal dimension that is sized to receive a pivot block 22 that extends from a corresponding end of the cable receiving handle 12. The cable clamping lever 14 fits over the pivot block 22 and pivot 18, which may be a pin, passes through both the cable clamping lever 14 and the pivot block 22 providing the hinged connection between the cable clamping lever 14 and the cable receiving handle 12.

As indicated by arrow “A,” the rotation about pivot 18 allows a limited degree of upward and downward motion of the clamping lever 14. This motion is limited in one direction by the cable receiving handle 12 and in the opposite direction by contact between one end of the cable clamping lever 14 and a stop 23 formed as part of the pivot block 22.

Supported by the clamping lever 14 is a clamping stud 24. The clamping stud 24 includes one end that freely slides within a journal 26 that is formed in a lower wall 25 of the cable receiving handle 12. The opposing end of the clamping stud 24 is threaded and projects through an opening in the clamping lever 14. Provided on the threaded end of the clamping stud 24, outward of the clamping lever 14, is an adjustment knob 28. The adjustment knob 28 is securely fastened to the clamping stud 24 by means of an adhesive, set screw, lock nut or any other suitable means.

A stop nut 30 is adjustably moveable along the length of the threaded portion of the clamping stud 24 and is located between the clamping lever 14 and the cable receiving handle 12. The external dimensions of stop nut 30 match the internal dimension of the clamping lever 14, thus preventing rotation of the stop nut 30. By rotating the adjustment knob 28, the clamping stud 24 is rotated and the stop nut 30 is caused to move along and relative to the threaded portion of the stud 24. Thus, the position of the stop nut 30 along the clamping stud 24 determines the extent to which the clamping stud 24 projects into the channel of the cable receiving handle 12, both initially and when the clamping lever 14 is squeezed toward the cable receiving handle 12.

A biasing means, such as a spring 32, presses outward between one side of the stop nut 30 and the periphery of the journal 26. The spring 32 therefore serves to bias the clamping lever 14 to an unclamped position.

In use, the clamping mechanism functions in the following manner. The spring 32 presses between one side of the stop nut 30 and the cable receiving handle 12 so as to bias the clamping handle 14 to the unclamped position. In the unclamped position the clamping stud 24 is retracted sufficiently to permit the cable C to be inserted or removed from the cable receiving handle 12. A cable to be cut is inserted into the channel 21 of the cable receiving handle 12 and adjustment knob 28 is rotated to bring the clamping stud 24 into position near the cable “C.” When the handle 12 and lever 14 are forced together, the clamping lever 14 presses against the stop nut 30, which forces the clamping stud 24 into clamping contact with the sheathing/armor of the cable C. Upon release of the clamping pressure, the spring 32 returns the clamping lever 14 to the unclamped position, ready for removal of the cable C from the channel 28 of the cable receiving handle 12.

If desired, another resilient means 34, such as a bowed spring washer, may be located between the stop nut 30 and the clamping lever 14. The resiliency of spring washer 34 prevents overstressing of the mechanical components that may occur when excess pressures are applied during the cutting operation.

As noted above, the clamping mechanism of the clamping lever 14 and cable receiving handle 12 is integrated with a saw. By clamping the cable C with the clamping mechanism, the cable C is securely held relative to the saw thereby allowing the armor to be cut without risk of injury to the operator or damage to the cable inside the armor.

In the preferred embodiment, the saw handle 16 pivots on the pivot 20 and a spring 36, located between the saw handle 16 and the cable receiving handle 12, biases the saw handle 16 to a non-cutting position spaced away from the cable receiving handle 12.

Provided in and supported by the saw handle 16, generally at the end opposite of the pivot 20, is a saw assembly 38. The saw assembly is comprised of two circular saw blades 40, 42 turned by a crank handle 44 and inter-disposed gears 46, 48, 50. Preferably, gear 46 is coaxial with the front saw blade 40 and gear 50 is coaxial with the rear saw blade 42. The gear 48 is disposed between the two gears 46, 50 so as to be driven by gear 46 and drive gear 50 (or vice versa), thereby allowing the crank handle 44 to simultaneously drive both saw blades 40, 42. As seen in FIGS. 1 and 2, the saw blades 40, 42 are mounted on the saw handle 16 so as to define a vertically oriented cutting plane (per the orientation of the figures) that is generally parallel with the longitudinal axis “Z” of the hand tool 10 and the cable C.

The handles and lever 12, 14, 16 are mounted such that they can be gripped in one hand by an operator. When all three are squeezed together, the cable C is securely clamped by the clamping stud 24 against an upper wall 52 of the cable receiving handle 12, and the clamping handle 12 and saw handle 16 are moved into a cutting position. In the cutting position, the front and rear saw blades 40, 42 extend through a slot 54 defined in the upper wall 52 opposite of the clamping stud 24 and journal 26. The front and rear saw blades 40, 42 are axially spaced so as to contact successive wraps “X” and “Y” of the armor of the cable C.

By turning the crank handle 44 and continuously squeezing the handles and lever 12, 14, 16, the saw blades 40, 42 are rotated and the wraps X and Y cut respectively thereby. A pin and slot configuration between the saw handle 16 and the cable receiving handle 12 can be provided to limit penetration limits the extent to which the saw blades 40, 42 penetrate into the cable C. This penetration is sufficient to completely cut through wraps X and Y, but is insufficient to cause damage to the individual conductors “W” within the cable C. (See FIG. 2) Alternatively, Engagement of the lower surface of the saw handle 16 with the upper wall 52 of the cable receiving handle 12.

Although a hand operated hand tool 10 is shown, an electrically powered hand tool 10 may also be provided by providing an electric or battery-operated motor to drive the saw blade 40, 42.

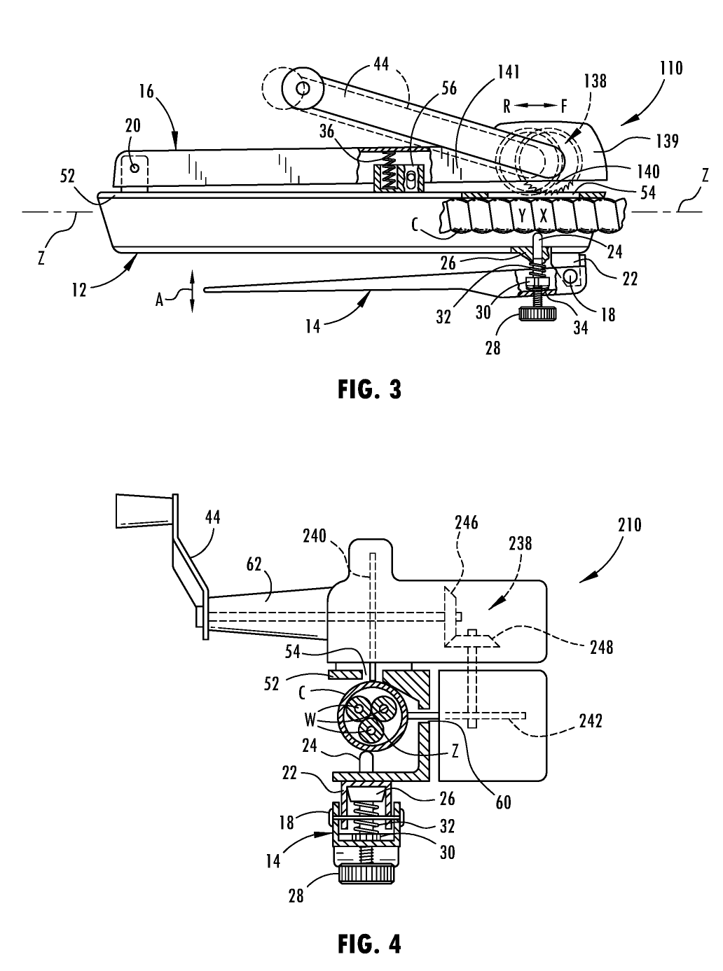

Referring now to FIG. 3, a hand tool 110 embodying the principles of the present invention is illustrated therein. The hand tool 110 includes numerous elements that are the same as those discussed in connection with FIGS. 1 and 2. Identical elements, accordingly, are identified with the same reference numeral and the discussion thereof is not repeated in the interest of brevity. Principally, the hand tool 110 of FIG. 3 differs from the hand tool 10 of FIGS. 1 and 2 in the construction of the saw assembly.

The saw assembly 138 seen in FIG. 3 is similarly provided in and supported by the saw handle 16, generally at the end opposite of the pivot 20. However, the saw assembly 138 is only comprised of one circular saw blade 140 turned by the crank handle 44. Like FIGS. 1 and 2, the saw blade 140 is mounted on the saw handle 16 to define a cutting plane that is generally parallel with the longitudinal axis “Z” of the hand tool 110 and the cable C.

The saw assembly 138 is moveable relative to the saw handle 16 between a forward position “F”, where the saw blade 140 is aligned with wrap X, and a rearward position “R”, where the saw blade 240 is aligned with wrap Y. The saw assembly 138 may therefore be mounted in a slot formed in the saw handle 16, allowing the above movement, and provided with an interlock mechanism to fixedly retain the saw assembly 138 in the forward and rearward positions F and R during operation of the crank handle 44. As such, the saw assembly 138 may be adjustably or slideably mounted to the forward end of the saw handle 16 and secured in position by a thumb screw coaxial with the rotational axis of saw blade 40. Alternatively, the forward end of the saw handle 16, including the saw assembly 138, may be adjustably or slideably mounted to the rearward end of the saw handle 16. For example, the hood 139, including the saw assembly 138, may be repositionable in notches of a slot formed in the end of the arm 141 of the saw handle 16.

With the saw assembly 138 in the forward position F, by turning the crank handle 44 and continuously squeezing the handles and lever 12, 14, 16, the saw blade 140 is rotated and cuts wrap X. Next, without unclamping the cable C, the saw assembly 138 is moved to the rearward position R and, by turning the crank handle 44 and continuing to squeeze the handles and lever 12, 14, 16, the saw blade 140 is rotated and cuts wrap Y. Like previously described, penetration of the blade 140 is sufficient to cut wraps X and Y of the cable C but is insufficient to cause damage to the individual conductors “W” within the cable C.

Referring now to FIG. 4, a hand tool 210 embodying the principles of the present invention is illustrated therein. The hand tool 210 includes numerous elements that are the same as those discussed in connection with the prior variations. Accordingly, identical elements are identified with the same reference numerals and the discussion thereof is not repeated in the interest of brevity. Principally, the hand tool 210 of FIG. 4 differs from the earlier discussed hand tools 10 in the construction of the saw assembly.

The saw assembly 238 seen in FIG. 4 is similarly provided in and supported by the saw handle 16, generally at the end opposite of the pivot 20. However, the saw assembly 238 is comprised of one circular saw blade 240 located above the cable C and one circular saw blade 242 located transverse to the cable C. Both saw blades 240, 242 are turned by the crank handle 44 and a series of inter-dispersed gears 246, 248, such as the tapered gears seen herein. The rear blade 242 is supported in a rear saw handle 58 that is mounted to the cable receiving handle 12 in a manner like the saw handle 16 previously discussed, but on the rear side of the cable receiving handle 12. Like FIGS. 1 and 2, the saw blades 240, 242 are mounted on the saw handle 16 to define cutting planes that are generally parallel with the longitudinal axis Z of the hand tool 210 and the cable C.

By continuously squeezing the handles and lever 12, 14, 16, the saw blade 240 is rotated by the crank handle 44 and caused to extend through the slot 54 to cut wrap X. Simultaneously, a rear handle 58 is also is squeezed toward the cable receiving handle 12 causing saw blade 242 to extend through slot 60 and cut wrap Y. To facilitate movement of saw blade 242 toward the cable C, gear 246 may translate axially along the drive shaft 62 extending from the crank handle 44 through saw blade 240, but be rotationally fixed with the drive shaft 62. Again, penetration of both blades 240, 242 is limited so that on the wraps X and Y will be cut and so that no damage is done to the conductor W or the insulation thereon.

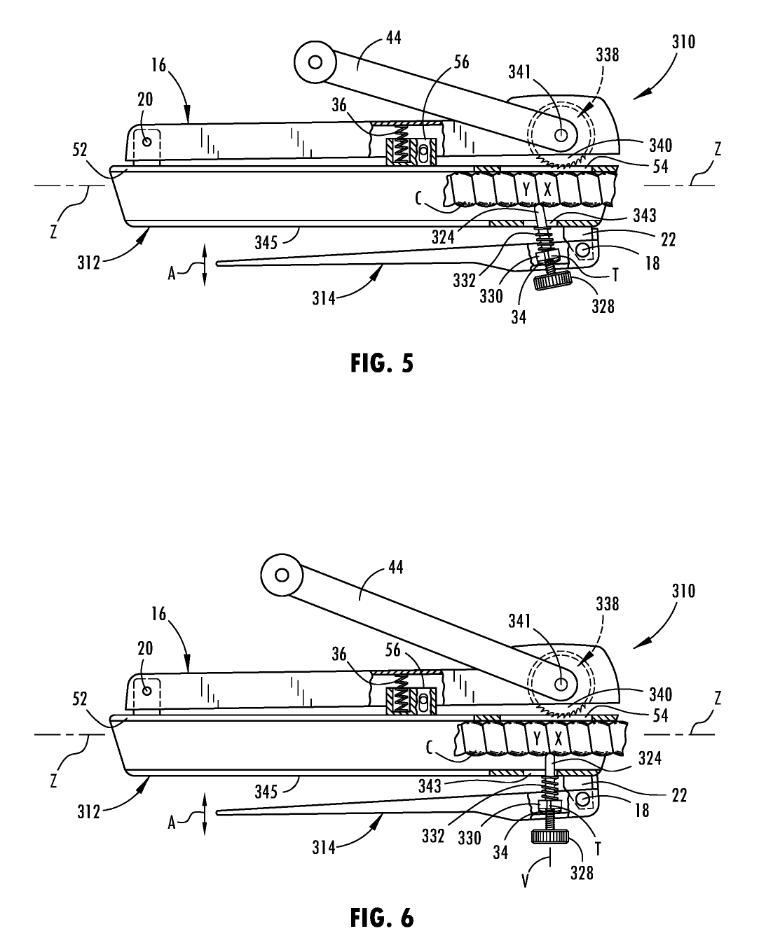

Referring now to FIGS. 5 and 6, a hand tool 310 embodying the principles of the present invention is illustrated therein. As with previously discussed variations, the hand tool 310 includes numerous elements that are the same as those discussed in connection with those variations. Identical elements are identified with the common reference numerals and the discussion thereof is not repeated in the interest of brevity. As will be appreciated for the following disclosure, the hand tool 310 of FIGS. 5 and 6 differs from the earlier discussed hand tools in the construction of the saw assembly and the clamping stud.

The saw assembly 338 includes a single saw blade 340 that is fixed in position relative to the saw handle 16 and rotatable about axle 341 by the crank handle 44. Unlike the prior variations, the clamping stem 324 and its related components are pivotable in the fore and aft directions along axis Z of the tool 310. As seen in FIG. 5, the clamping stem 324 extends through a slot 343 in a lower wall 345 of the cable receiving handle 312 and is pivoted into its rearward position. In this rearward position, the clamping stem 324 is angled toward the rear of the tool 310, which is toward the left in the FIG. 5. As seen in FIG. 6, the clamping stem 324 has been pivoted from the rearward position into its forward position. In the forward position, the clamping stem 324 is substantially upright, but could be in any orientation along the axis Z that is forward (toward the right in the FIG.) of the rearward position.

The clamping stem 324 is mounted in the clamping lever 314 in a manner permitting the above described pivoting movement. As such, the stop nut 330 may be pivotally secured to the clamping lever 314 for rotation about an axis T transverse to the axis Z of the hand tool 310. Securing the stop nut 330 in this manner also serves to prevent rotation of the stop nut 330 about the longitudinal axis of the clamping stem 324 and allows the clamping stem 324 to be advanced or retracted, relative to the cable C, by rotation of the adjustment knob 328 on the end of the clamping stem 324. A spring 332 is provided about the clamping stem 324 between the stop nut 330 and portions of the lower wall 345 defining the sides of the slot 343. As a result, the spring 332 operates to bias the clamping lever 314 away from the cable receiving handle 12.

During use, the clamping stem 324 is pivoted into its rearward position, as seen in FIG. 5, by moving the adjustment knob 328 in a forward direction. The clamping lever 314 may then be lightly squeezed towards the cable receiving handle 12 and the adjustment knob 328 rotated to advance the clamping stem 324 into engagement with the cable C. To facilitate engagement with the cable C, the end of the clamping stem 324 may be provided with a recessed shape to receive the cable C therein or another shape to engage between adjacent wraps of the cable C.

With the clamping stem 324 engaged with the cable C, the clamping lever 314 may be further squeezed so as to impinge and secure the cable C against the upper wall 52. By squeezing together the saw handle 16 and the cable receiving handle 12, the blade 340 is caused to extend through the slot 54 in the upper wall 52 of the cable receiving handle 12 and to engage the cable C. Thereafter rotation of the crank handle 44 causes the saw blade 340 to cut wrap X of the cable C.

Once wrap X has been completely cut by the saw blade 340, the squeezing force can be lessened and, by pulling rearward on the adjustment knob 328, the clamping stem 324 moved forward into its forward position. To aid in this movement, the securement of the stop nut 330 about axis T may be such that it allows for limited movement along axis V. By retaining the clamping stem 324 in engagement with the cable C during the pivoting movement, the cable C is also moved forward with the clamping stem 324. In this regard, the forward end of the slot 343 may be used to limit the pivoting movement and establish the forward position of the clamping stem 324 such that wrap Y of the cable C is properly positioned to be cut by the saw blade 340. Squeezing and operation of the saw assembly 338 may then be repeated to cut wrap Y.

With the above discussed constructions, embodiments of a hand tool are provided that can facilitate the cutting of two successive wraps of armored cable. Accordingly, the hand tools will find use in the cutting of the metal sheathing of armored cable defined by a single wrap of material, but also in the cutting of armored cable where the sheathing is defined two or more separate wraps of metallic or other armor material.

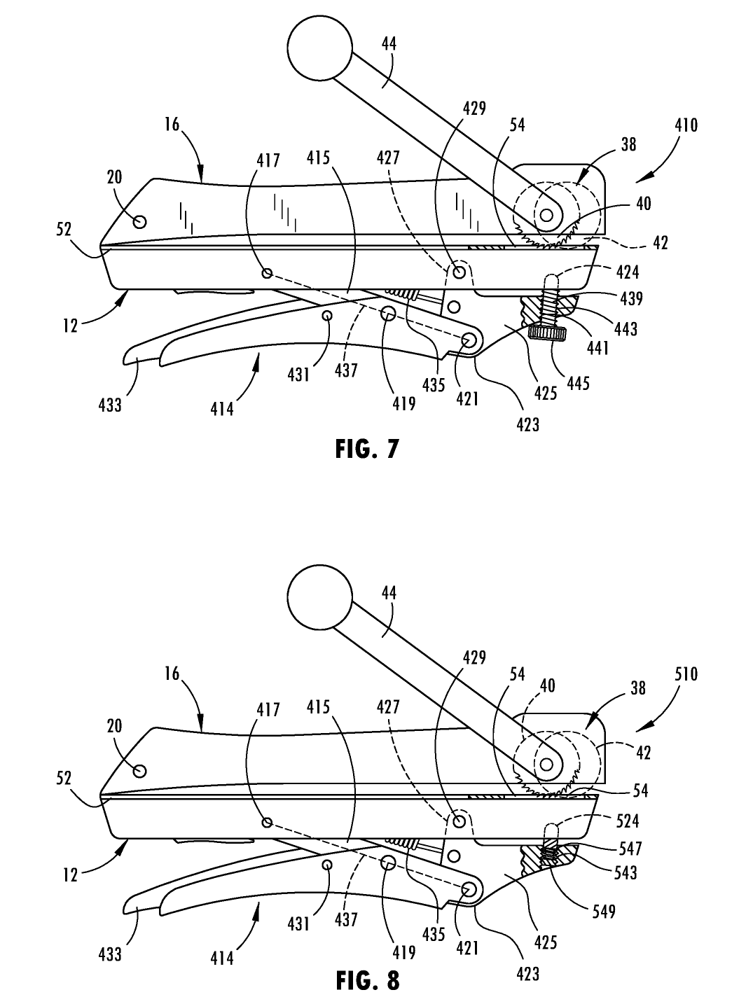

Referring now to FIG. 7, a hand tool 410 embodying the principles of the present invention is illustrated therein. As with previously discussed variations, the hand tool 410 includes numerous elements that are the same as those discussed in connection with those variations. Identical elements are identified with the common reference numerals and the discussion thereof is not repeated in the interest of brevity. As will be appreciated for the following disclosure, the hand tool 410 of FIG. 7 differs from the earlier discussed hand tools in the construction of the clamping lever 414.

The saw assembly 38 seen in FIG. 7 is similarly provided in and supported by the saw handle 16 as discussed above in connection with FIG. 1. By squeezing the handles and lever 12, 414, 16 together, the saw blades 40, 42 are pivoted about pivot 20 and caused to extend through the slot 54 to engage the armor of the cable C (not shown). Rotation of the crank handle 44 causes the saw blades 40, 42 to penetrate through the wraps (not shown) of the cable C.

For operator convenience, the clamping lever 414 is capable of locking in a clamped position. In order to achieve locking, the clamping lever 414 is connected to the cable receiving handle 12 by a connecting rod 415. The connecting rod 415 extends from a first pivot 417 in the handle 12 to a second pivot 419 in the clamping lever 414.

The clamping lever 414 also includes a third pivot 421, which is located forward (toward the right in FIG. 7) of the second pivot 419 and at the forward most end of the clamping lever 414. This third pivot 421 couples the clamping lever 414 with a pawl 423 of a moveable linkage 425. The moveable linkage 425 includes a second pawl 427 in which is fourth pivot 429 is provided in association with the cable receiving handle 12.

The locking in the clamped position operates on a 4 bar-linkage principle where the relationship of first, second and third pivot 417, 419, 421 is able to move to an over-center position, seen in FIG. 7, where the second pivot is above a centerline 437 defined between the first and third pivots 417, 421. In the over-center position, the moveable linkage 425 is caused to rotate, counter clockwise in FIG. 7, causing a clamping stem 424 to be brought into engagement with the cable C and forcing the cable C into engagement with the saw blades 40, 42.

Mounted to the clamping lever 414 at pivot 431 is a release lever 433. By lifting on the release lever 433, the clamping lever 414 is caused to move downward, away from and cable receiving handle 12. This movement is aided by a spring 435 extended between the cable receiving handle 12 and the moveable linkage 425. With this movement of the clamping lever 414, the moveable linkage 425 is cause to rotate counter clockwise about the fourth pivot 429 and the second pivot 419 moves to a position below the centerline 437. In this position, the clamping stem 424 is positioned away from the cable C.

To accommodate different sized cables, the clamping stem 424 is adjustable relative to the moveable linkage 425. As seen in FIG. 7, the clamping stem 424 is provided with external threads 439 that engage corresponding internal threads 441 of a bore 443 through the moveable linkage 425. For easy adjustment, the clamping stem 424 includes a thumb screw or knob 445 on its distal end.

In an alternative embodiment to that of FIG. 7, instead of being adjustable via the thumb screw 445, the hand tool 510 of FIG. 8 includes a clamping stem 524 that is spring biased. A spring 547 is coupled to the distal end of the clamping stem 524 and operates to bias the spring toward the cable C. The clamping stem 524 and spring 547 may be received in a bore 543 that extends part way through the moveable linkage 425 or may be retained therein by an end cap 549 engaged with threads in the bore 543.

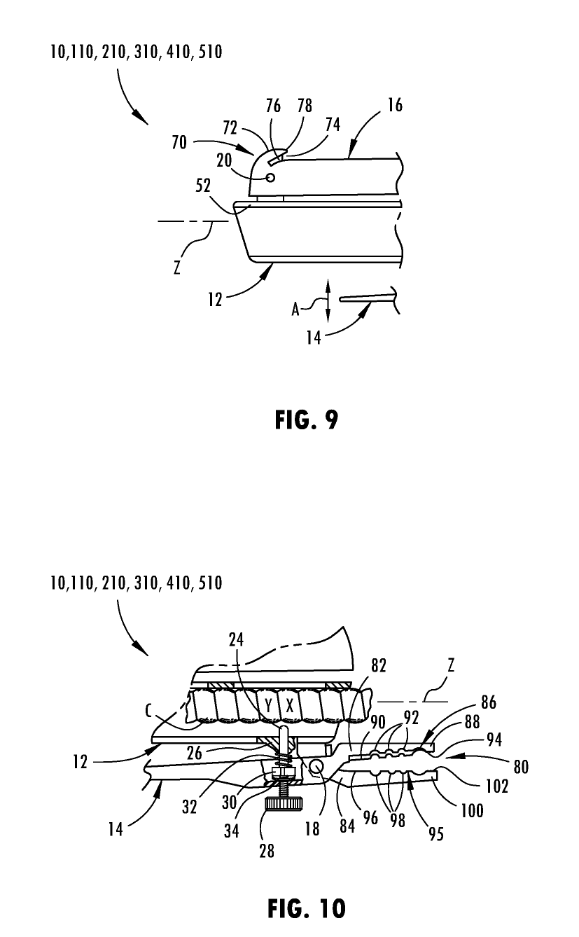

As represented in FIG. 9, a hand tool embodying the principles of the present invention may additionally incorporate a tape cutter 70 into its construction. As illustrated, the tape cutter 70 is provided on an upper end of the saw handle 16 adjacent to the pivot 20. The tape cutter 70 includes a guard 72 defining a recess 74 within which fixed blade 76 is positioned. Preferably, the blade 76 is set back within the recess 74 such that the fixed blade 76 will not be inadvertently contacted by a user's hand or fingers. Thus, the tip 78 of the guard 72 extends over and beyond the leading edge of the fixed blade 76. As will be readily appreciated, the tape cutter 70 may be incorporated into any of the hand tools 10, 110, 210, 310, 410, 510 seen in FIGS. 1 and 3-5, 7, 8, which is the intended representation by the partial view of the FIG. 9, as well as any of the hand tools of the disclosures incorporated by reference.

Referring now to FIG. 10, a hand tool embodying the principles of the present invention may additionally incorporate wire stripping pliers 80 into its construction. As seen in FIG. 10, the wire stripping pliers 80 include an upper jaw 82 and a lower jaw 84. The upper jaw 82 is formed unitarily or integrally as an extension of the clamping lever 14, forward of the pivot 18. The lower jaw 84 is similarly formed unitarily or integrally as an extension of the cable receiving handle 12, forward of the pivot 18.

An inner edge of one of the jaws 82, 84 is formed as a knife edge 86 that is ground and sharpened (this is illustrated as the upper jaw 82 in FIG. 10) and which extends over a majority of the length of the jaw 82, except for the terminal end portion 88. The knife edge 86 includes a straight section 90 for cutting wire and a series of semi-circular recesses 92 for cutting and stripping insulation from various gage wires. The terminal end portion 88 of the jaw 82 is provided with a toothed grip 94 that includes both rounded and straight sections for versatility when gripping is needed.

An inner edge of the opposing jaw 82, 84 (illustrated as the lower jaw 84) is formed as an opposing edge 94. The opposing edge 94 need not be ground or sharpened, but may be so provided if desired. Like the knife edge 86, the opposing edge 94 includes a straight section 96 and a series of semi-circular recesses 98. The straight section 96 cooperates with the straight section 90 of the knife edge 86 for cutting wire and the series of semi-circular recesses 98 cooperate with the semi-circular recesses 92 of the knife edge 86 for cutting and stripping insulation from various gage wires. The terminal end portion 100 of the lower jaw 84 is similarly provided with a toothed grip 102 that includes both rounded and straight sections, which cooperate with the round and straight section of the toothed grip 94 of the upper jaw 82.

As provided, the upper and lower jaws 82, 84 of the wire pliers 80 provide the hand tool added functionality enabling the grasping, manipulation and cutting of conductors W stripped of the armored sheathing, as well as the stripping of insulation from the conductors W themselves.

The wire stripping pliers 80 may be incorporated into any of the hand tools 10, 110, 210, 310, 410, 510, seen in FIGS. 1, 3-5, 7 and 8, which is the intended representation by the partial view of the FIG. 10, as well as any of the hand tools of the disclosures incorporated by reference.

As a person skilled in the art will really appreciate, the above description is meant as an illustration of at least one implementation of the principles of the present invention. This description is not intended to limit the scope or application of this invention since the invention is susceptible to modification, variation and change without departing from the spirit of this invention, as defined in the following claims. The terminology used herein is therefore intended to be understood in the nature of words of description and not of limitation.

We claim:

1. A stripping tool for cutting the armor sheathing of a cable, the tool comprising:
a cable receiving handle defining a cable receiving channel;
a saw handle movably mounted to the cable receiving handle; and
a saw assembly including at least one saw blade, the saw assembly supported by the saw handle and being moveable relative to the cable receiving handle, the saw assembly configured to cut two successive wraps of the armor sheathing of the cable.

2. The stripping tool according to claim 1, wherein the saw assembly includes two rotatable saw blades

3. The stripping tool according to claim 2, wherein the saw blades are axially spaced from one another.

4. The stripping tool according to claim 2, wherein the saw blades are rotationally coupled to one another.

5. The stripping tool according to claim 4, wherein the saw blades are rotationally coupled to one another by a series of gears.

6. The stripping tool according to claim 1, wherein the saw assembly includes two saw blades laterally spaced from one another.

7. The stripping tool according to claim 1, wherein the saw assembly includes two saw blades that are laterally and axially spaced from one another.

8. The stripping tool according to claim 1, wherein the saw assembly includes a saw blade axially moveable relative to the cable receiving handle between forward and rearward positions.

9. The stripping tool according to claim 1, wherein the saw assembly is axially moveable relative to the cable receiving handle between forward and rearward positions.

10. The stripping tool according to claim 1, wherein the saw handle is mounted to the cable receiving handle at one end of the saw handle and the saw assembly is mounted at an opposing end of the saw handle.

11. The stripping tool according to claim 1, further comprising a cable engaging member that is pivotally mounted relative to the cable receiving handle and pivotable between a rearward position and a forward position, the rearward position of the cable engaging member positioning the cable for cutting of one wrap of the armor sheathing by the saw assembly and the forward position of the cable engaging member positioning the cable for cutting of a successive wrap of the armor sheathing by the saw assembly.

12. The stripping tool according to claim 1, further comprising an integrated tape cutter formed on one of the saw handle and cable receiving handle, the tape cutter including a fixed blade.

13. The stripping tool according to claim 1, further comprising an integrated wire stripping plies formed at least in part on the cable receiving handle, the wire stripping pliers including opposing jaws moveable relative to one another and a cutting edge defined on one of the opposing jaws.

14. The stripping tool according to claim 1, further comprising a clamping lever pivotably mounted to the cable receiving handle, the clamping lever coupled to a clamping stud extending toward the saw assembly and into the channel defined in the cable receiving handle for engagement with a cable located therein.

15. The stripping tool according to claim 14, wherein the clamping stud is pivotally mounted relative to the clamping lever and pivotable between a rearward position and a forward position, the rearward position of the cable engaging member positioning the cable for cutting of one wrap of the armor sheathing by the saw assembly and the forward position of the cable engaging member positioning the cable for cutting of a successive wrap of the armor sheathing by the saw assembly.

16. The stripping tool according to claim 14, wherein the clamping lever is moveable between a locked clamped position and an unclamped position.

17. The stripping tool according to claim 16, further including a connecting rod extending between the cable receiving handle and the clamping lever, the connecting rod being respectively pivotally connected to each of the cable receiving handle and the clamping lever at first and second pivots, a moveable linkage extending between the clamping lever and the cable receiving handle, the moveable linkage being respectively pivotally connected to each of the clamping lever and the cable receiving handle at third and fourth pivots.

18. The stripping tool according to claim 17, wherein the first and third pivots define a centerline therebetween and the second pivot is moveable between the locked clamped position on one side of the centerline and the unclamped position on the opposing side of the centerline.

19. The stripping tool according to claim 17, wherein the clamping stud is supported by the moveable linkage.

20. The stripping tool according to claim 19, wherein the clamping stud threadably engaged with the moveable linkage and adjustable in position relative thereto.

21. The stripping tool according to claim 19, wherein the clamping stud is received in a bore of the moveable linkage and biased with respect thereto by a spring.
